(19) United States
(12) Patent Application Publication
(10) Pub. No.: US 2025/0145476 A1
(43) Pub. Date: May 8, 2025

(54) METHOD FOR PURIFYING ELECTRONIC-GRADE BORON TRICHLORIDE

(71) Applicant: DALIAN CREDITCHEM ELECTRONIC MATERICAL CO., LTD., Dalian (CN)

(72) Inventors: Yi Zhao, Dalian (CN); Ying Liu, Dalian (CN); Yinfeng Zhao, Dalian (CN); Congzhi Bi, Dalian (CN); Ying Yu, Dalian (CN)

(21) Appl. No.: 18/288,891

(22) PCT Filed: Oct. 25, 2022
(86) PCT No.: PCT/CN2022/127323

§ 371 Date: Jan. 14, 2025

(30) Foreign Application Priority Data
Sep. 23, 2022 (CN) 2022111672064

(51) Int. Cl. C01B 35/06; B01J 20/04; B01J 20/06; B01J 20/20; B01J 20/22; B01J 20/30

(52) U.S. Cl. CPC C01B 35/061; B01J 20/041; B01J 20/06; B01J 20/20; B01J 20/22; B01J 20/3078; B01J 20/3085

(57) ABSTRACT

The present disclosure relates to the field of special electronic gases, in particular to a method for purifying electronic-grade boron trichloride. The method includes the following steps: (S.1), filling an adsorption composition into adsorbers; (S.2), vacuumizing the adsorbers to remove air from the adsorbers, and then introducing a high-purity boron trichloride gas; and (S.3), introducing a boron trichloride feed gas into the adsorbers, such that the boron trichloride feed gas is in contact with the adsorption composition, and collecting a gas flowing out of the adsorbers to obtain an electronic-grade boron trichloride gas. According to the present disclosure, coordination formed between hydrogen chloride impurities and boron trichloride can be eliminated effectively, thereby improving adsorption and purification effects of the boron trichloride. Meanwhile, the adsorption composition in the present disclosure has an excellent adsorption effect on an impurity gas, and a concentration of the impurity gas in the boron trichloride obtained after simple adsorption treatment can be decreased to a ppb (part per billion) level.

### CROSS REFERENCE TO RELATED APPLICATIONS

This is a national stage application of PCT International Application No. PCT/CN2022/127323, filed Oct. 25, 2022, which claim priority to Chinese Patent Application No. 2022111672064, filed Sep. 23, 2022; the disclosure of which are incorporated herein by reference in their entireties.

### TECHNICAL FIELD

The present disclosure relates to the field of special electronic gases, in particular to a method for purifying electronic-grade boron trichloride.

### BACKGROUND ART

In the production of semiconductor integrated circuits, electronic gases are indispensable core support gases. Boron trichloride serves as an important electronic gas, which can be used in diffusion, ion implantation and dry etching of silicon semiconductor components, production of solar cell modules and other processes.

With the development of an IC (integrated circuit) manufacturing process and technology, a chip size is increasing, and a line width of a feature size is decreasing, which requires continuous improvement of the purity and specific indexes of various electronic gases used in the IC manufacturing process. The currently required purity is mostly above 99.999% (5N); and thus, how to purify the boron trichloride is an important direction for the localization of electronic gases.

### Technical Problem

Generally, impurities in low-purity boron trichloride include metallic and gaseous impurities, which can make IC features changed, enable devices to gradually fail, shorten service cycles of the devices, cause a negative effect on the credibility of components, and even result in contamination to a whole production line due to diffusion of gases failing to meet the requirements.

A method for purifying boron trichloride in the prior art can specifically refer to the following patents:
A boron trichloride purification device with an application number of CN202110827964.3;
A dehydrochlorination device for purifying boron trichloride and a boron trichloride purification system with an application number of CN202210222173.2.

As shown in the above patents, the purification process of the boron trichloride in the prior art is generally implemented by a distillation or physical/chemical adsorption method, however, the applicant found that some impurity gases are hard to separate from the boron trichloride by such method. Specifically for hydrogen chloride in the boron trichloride, due to its ability to form a complex with the boron trichloride, the hydrogen chloride is hard to remove from a boron trichloride gas, and consequently the purity of the boron trichloride finally obtained is lower, and hard to reach 99.999% (5N) above.

### Technical Solution

In order to overcome the shortcomings that the boron trichloride in the prior art is hard to separate and purify by conventional distillation or physical/chemical adsorption technical means, the present disclosure provides a method for purifying electronic-grade boron trichloride to overcome the above shortcomings.

In order to achieve the above objective of the present disclosure, the present disclosure provides the following technical solution:
In a first aspect, the present disclosure first provides an adsorption composition, including
an ionic liquid, and a solid adsorbent dispersed in the ionic liquid;
the solid adsorbent includes an adsorption carrier and a metal oxide loaded on a surface of the adsorption carrier; and
an outside surface of the solid adsorbent is further coated with a carbon layer.

The applicant found in the research that as a boron atom in the boron trichloride contains a vacant orbital, the boron trichloride may form a coordinate bond with substances (such as hydrogen chloride) containing lone-pair electrons, and consequently impurities containing lone-pair electrons are hard to separate from the boron trichloride by a conventional technical means of distillation. Therefore, how to break the coordinate bond between the boron trichloride and the impurities containing the lone-pair electrons is the key to the purification of the boron trichloride.

The inventor of the present disclosure provides a novel solution for the above problems. The inventor of the present disclosure found that hydrogen chloride molecules may be ionized in an ionic liquid to form hydrogen ions and chloride ions, wherein the chloride ions may continue to be linked to the boron trichloride by coordination, while the hydrogen ions may be dissociated in the ionic liquid. As a result, the hydrogen ions may react with the metal oxide loaded on the surface of the solid adsorbent by acid-base neutralization, and accordingly, metal ions are dissociated from the metal oxide. These obtained metal ions may also be coordinated with the chloride ions. As the coordination between the metal ions and the chloride ions is stronger than that between the boron trichloride and the chloride ions, the metal ions are able to trapping the chloride ions coordinated with the boron trichloride, and therefore the coordinate bond between the boron trichloride and the chloride ions is broken, such that the boron trichloride may be dissociated.

Meanwhile, as the boron trichloride is a non-polar solute, while the polarity of the ionic liquid is higher, the interaction between the boron trichloride solutes and the interaction between the solutes and the ionic liquid are much smaller than that between the ionic liquids. Therefore, solute molecules (boron trichloride) are “extruded” out of the ionic liquid, while other polar impurity gases in the boron trichloride are easy to adsorb by the ionic liquid based on the principle that like dissolves like, and thus the pure boron trichloride is easy to separate from the ionic liquid.

As vapor pressure of the ionic liquid is almost close to zero, the problem of contamination to the boron trichloride gas by volatilization of the ionic liquid will not be raised.

In addition, the outside surface of the solid adsorbent is further coated with a carbon layer in the present disclosure, which aims to improve a purification effect of the boron trichloride gas. The principle is that the setting of the carbon layer may increase a surface area of the solid adsorbent, thereby improving a physical adsorption effect of the impurity gas in the boron trichloride. Meanwhile, after coming in contact with the carbon layer, boron trichloride bubbles may enter pores in the carbon layer to form microbubbles, and therefore the reaction with the metal oxide is more thorough. Meanwhile, the setting of the carbon layer may also make the metal oxide loaded on the surface of the adsorption carrier more stable to avoid the situation that the metal oxide is shed under the impact of the boron trichloride gas and consequently the adsorption purification effect of the gas is affected.

As a preference, the ionic liquid includes one or a combination of more of an imidazolium ionic liquid, a quaternary ammonium ionic liquid, a quaternary phosphonium ionic liquid, a pyrrolidine ionic liquid and a piperidine ionic liquid.

As a preference, a positive ion of the ionic liquid is any one of N-hexylpyridine, N-butylpyridine, N-octylpyridine, N-butyl-N-methylpyrrolidine, 1-butyl-3-methylimidazole, 1-propyl-3-methylimidazole, 1-ethyl-3-methylimidazole, 1-hexyl-3-methylimidazole, 1-octyl-3-methylimidazole, 1-allyl-3-methylimidazole, 1-butyl-2, 3-dimethylimidazole, 1-butyl-3-methylimidazole, tributylmethylphosphine, tributylethylphosphine, tetrabutylphosphine, tributylhexylphosphine, tributylhexylphosphine, tributyloctylphosphine, tributyldodecylphosphine, tributyltetradecylphosphine, triphenylethylphosphine, triphenylbutylphosphine, triphenylmethylphosphine, triphenylpropylphosphine, triphenylpentylphosphine, triphenylacetonephosphine, triphenylbenzylphosphine, triphenyl(3-bromopropyl)phosphine, triphenylbromomethylphosphine, triphenylmethoxyphosphine, triphenylethoxycarbonylmethylphosphine, triphenyl(3-bromopropyl)phosphine, triphenylvinylphosphine and tetraphenylphosphine.

As a preference, a negative ion of the ionic liquid is any one of BF₄⁻, PF₆⁻, CF₃SO₃⁻, (CF₃SO₂)₂N⁻, C₃F₇COO⁻, C₄F₉SO₃, CF₃COO⁻, (CF₃SO₂)₃C⁻, (C₂F₅SO₂)₃C⁻, (C₂F₅SO₂)₂N⁻ and SbF₆⁻.

As a preference, the ionic liquid includes 1-butyl-3-methylimidazolium trifluoromethanesulfonate, 1-butyl-3-methylimidazolium dicyanamide, 1-ethyl-3-methylimidazolium trifluoroacetate, 1-ethyl-3-methylimidazolium chloroaluminate, 1-ethyl-2,3-dimethylimidazolium tetrafluoroborate, 1-hexyl-3-methylimidazolium bis(trifluoromethylsulfonyl)imide, 1-allyl-3-methylimidazolium bis(trifluoromethanesulfonyl)imide, 1-ethyl-3-methylimidazolium chloride, 1-ethyl-3-methylimidazolium bis(trifluoromethanesulfonyl)imide, 1-sulfobutyl-2-methyl-3-hexadecylimidazolium hydrogensulfate, 1-ethyl-3-methylimidazolium tetrafluoroborate, 1-ethyl-3-methylimidazolium carbonate, 1-ethyl-3-methylimidazolium L-lactate, 1,3-dimethylimidazolium hexafluorophosphate, 1-ethyl-3-methylimidazolium hexafluorophosphate, 1-propyl-3-methylimidazolium hexafluorophosphate, 1-butyl-3-methylimidazolium hexafluorophosphate, 1-hexyl-3-methylimidazolium hexafluorophosphate, 1-octyl-3-methylimidazolium hexafluorophosphate, 1-decyl-3-methylimidazolium hexafluorophosphate, 1-tetradecyl-3-methylimidazolium hexafluorophosphate, 1-benzyl-3-methylimidazolium hexafluorophosphate, 1-allyl-3-methylimidazolium hexafluorophosphate, 1-vinyl-3-ethylimidazolium hexafluorophosphate, 1-vinyl-3-butylimidazolium hexafluorophosphate, 1-cetyl-2,3-dimethylimidazolium hexafluorophosphate, 1-octyl-2,3-dimethylimidazolium hexafluorophosphate, 1,3-dimethylimidazolium tetrafluoroborate, 1-butyl-3-methylimidazolium tetrafluoroborate, 1-decyl-3-methylimidazolium tetrafluoroborate, 1-benzyl-3-methylimidazolium tetrafluoroborate, 1-ethyl-2,3-dimethylimidazolium tetrafluoroborate, 1-propyl-2,3-dimethylimidazolium tetrafluoroborate, 1-octyl-2,3-dimethylimidazolium tetrafluoroborate, 1-octyl-2,3-dimethylimidazolium tetrafluoroborate.

As a preference, the adsorption carrier includes one or a combination of more of silica gel powder, diatomaceous earth, laminated graphite and activated carbon.

The adsorption carriers used in the present disclosure are all inert carriers, which may not react with the boron trichloride to avoid a decrease in the yield of the boron trichloride.

As a preference, the metal oxide includes one or more of oxides of zinc, aluminum, magnesium, iron, manganese and copper.

As a preference, the metal oxide must contain the copper oxide.

The metal oxide used in the present disclosure has high reaction activity with the hydrogen chloride, such that hydrogen chloride gas impurities doped in the boron trichloride can be adsorbed effectively, and meanwhile an effective and stable coordination with the chloride ions can be formed. Meanwhile, the inventor also found that the copper oxide has a better absorption effect on impurities in the boron trichloride in the ionic liquid during the screening process.

In a second aspect, the present disclosure further provides a method for preparing the adsorption composition, including the following steps:
(1) dispersing an adsorption carrier into a solution containing a soluble metal salt and a carbon-containing monomer to form a dispersion;
(2) regulating a pH of the dispersion to alkalinity, such that the soluble metal salt is converted into a metal hydroxide and the carbon-containing monomer is converted into a carbon precursor, thus the metal hydroxide and the carbon precursor are together loaded on a surface of the adsorption carrier;
(3) performing heat treatment to the adsorption carrier loaded with the metal hydroxide and the carbon precursor in an inert atmosphere, to obtain a solid adsorbent; and
(4) dispersing the solid adsorbent into an ionic liquid to form the adsorption composition.

The preparation method of the adsorption composition in the present disclosure is simple, wherein the solid adsorbent is prepared by loading the metal hydroxide and the carbon precursor on the surface of the adsorption carrier, and then converting the carbon precursor into the carbon layer through heat treatment.

As a preference, the soluble metal salt includes soluble salts of zinc, aluminum, magnesium, iron, manganese, and copper.

As a preference, the carbon-containing monomer is any one of dopamine or tannin.

As a preference, the heat treatment in step (3) is conducted at 500-800° C. for 3-8 h.

It should be noted that the carbon coating process also needs a heat treatment step; and in order to maintain the stability of the carbon layer in the heat treatment process, the gas atmosphere in the heat treatment process should be maintained in reducing gas or inert gas.

In a third aspect, the present disclosure further provides a method for purifying electronic grade boron trichloride, including the following steps:
(S.1) filling the adsorption composition into adsorbers;
(S.2) vacuumizing the adsorbers to remove air from the adsorbers, and then introducing a high-purity boron trichloride gas; and
(S.3) introducing a boron trichloride feed gas into the adsorbers, such that the boron trichloride feed gas is in contact with the adsorption composition, and collecting a gas flowing out of the adsorbers to obtain an electronic-grade boron trichloride gas.

According to the present disclosure, in the purification process of the boron trichloride, only the boron trichloride feed gas needs to be introduced to the adsorbers filled with the adsorption composition, such that the boron trichloride feed gas is in contact with the adsorption composition, and then impurities in the boron trichloride feed gas may be adsorbed effectively. By actual tests, after adsorption, the content of the impurity gas in the boron trichloride gas may be decreased to a ppb level, and the effect is excellent.

As a preference, the temperature of contact between the boron trichloride feed gas and the adsorption composition in step (S.3) ranges from 25° C. to 35° C.

In a fourth aspect, the present disclosure further provides a boron trichloride purification system, wherein
it includes a feed gas tank, an adsorption assembly, a trapping assembly and a product tank which are connected in sequence by pipelines;
the adsorption assembly includes a plurality of adsorbers which are connected with each other in series, and at least one adsorber is filled with the above adsorption composition.

As a preference, the adsorption assembly includes a primary adsorber, a secondary adsorber and a tertiary adsorber which are connected in sequence;
the primary adsorber and the tertiary adsorber are filled with any one of activated carbon, a 13× molecular sieve, and a mordenite molecular sieve, respectively;
the secondary adsorber is filled with the adsorption composition as described above;
the trapping assembly comprises a trapping bottle connected with the adsorption assembly; and
a cold trap is arranged outside the trapping bottle in a sleeving manner.

### Beneficial Effects

Thus, the present disclosure has the following beneficial effects:
(1) According to the present disclosure, the coordination formed between hydrogen chloride impurities and boron trichloride can be eliminated effectively, thereby improving the adsorption and purification effects of the boron trichloride;
(2) The preparation method of the adsorption composition in the present disclosure is simple, the adsorption effect on the impurity gas is excellent, and a concentration of the impurity gas in the boron trichloride obtained after simple adsorption treatment can be decreased to the ppb (part per billion) level.

### BRIEF DESCRIPTION OF THE DRAWINGS

FIG. 1 is an electron micrograph of a solid adsorbent A according to the present disclosure.

FIG. 2 is a structural schematic diagram of a boron trichloride purification system in the present disclosure.

Wherein: a feed gas tank 100, an adsorption assembly 200, a primary adsorber 211, a secondary adsorber 212, a tertiary adsorber 213, a trapping assembly 300, a trapping bottle 310, a cold trap 320, and a product tank 400.

### DETAILED DESCRIPTION OF THE PRESENT DISCLOSURE

The present disclosure will be further described with reference to drawings of the specification and specific embodiments. A person having ordinary skill in the art can implement the present disclosure based on these descriptions. Furthermore, the embodiments of the present disclosure involved in the following description are merely a part of embodiments of the present disclosure, and not all of the embodiments. Therefore, all other embodiments obtained by a person having ordinary skill in the art based on the embodiments in the present disclosure without involving inventive effort should fall within the protection scope of the present disclosure.

### [Preparation of Solid Adsorbent]

### Solid Adsorbent A:

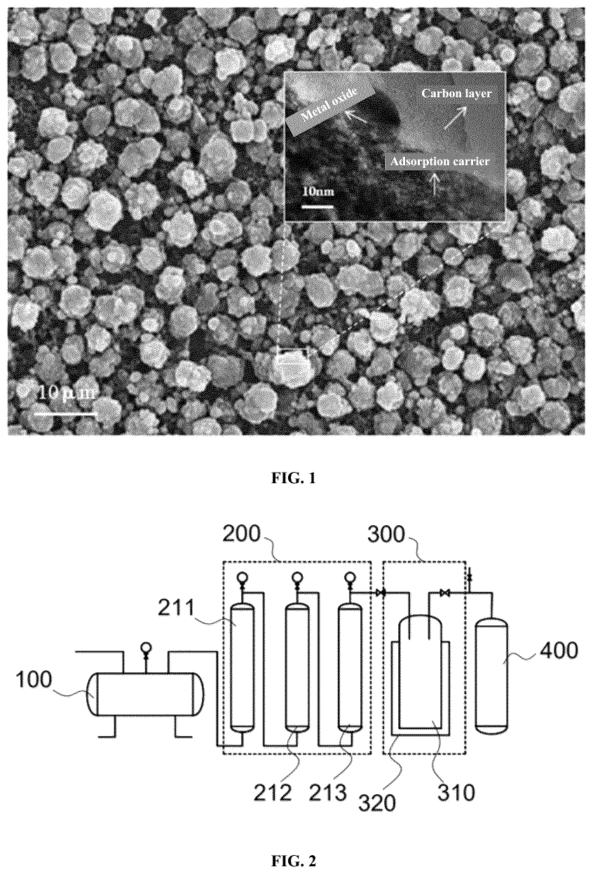

(1) 100 parts of silica gel powder are dispersed in 300 parts of solution containing 0.1 mol/L zinc chloride and 0.1 mol/L dopamine to form a dispersion;
(2) air is introduced into the dispersion at a rate of 100 ml/min, and a 0.5 mol/L sodium hydroxide solution is dropwise added to regulate the pH of the dispersion to alkalinity, such that the zinc chloride is converted into zinc hydroxide and dopamine is converted into polydopamine, and thus the zinc hydroxide and the polydopamine are together loaded on a surface of an adsorption carrier; and
(3) the adsorption carrier loaded with the zinc hydroxide and the polydopamine is heated to 500° C. under nitrogen and held for 8 h, and then naturally cooled to obtain a solid adsorbent A, wherein an electron micrograph of the solid adsorbent A is shown in FIG. 1.

### Solid Adsorbent B:

(1) 100 parts of silica gel powder are dispersed in 300 parts of solution containing 0.1 mol/L magnesium chloride and 0.1 mol/L dopamine to form a dispersion;
(2) air is introduced into the dispersion at a rate of 100 ml/min, and a 0.5 mol/L sodium hydroxide solution is dropwise added to regulate the pH of the dispersion to alkalinity, such that the magnesium chloride is converted into magnesium hydroxide and dopamine is converted into polydopamine, and thus the magnesium hydroxide and the polydopamine are together loaded on a surface of an adsorption carrier; and
(3) the adsorption carrier loaded with the magnesium chloride and the polydopamine is heated to 500° C. under nitrogen and held for 8 h, and then naturally cooled to obtain a solid adsorbent B.

### Solid Adsorbent C:

(1) 100 parts of silica gel powder are dispersed in 300 parts of solution containing 0.1 mol/L ferric chloride and 0.1 mol/L dopamine to form a dispersion;
(2) air is introduced into the dispersion at a rate of 100 ml/min, and a 0.5 mol/L sodium hydroxide solution is dropwise added to regulate the pH of the dispersion to alkalinity, such that the ferric chloride is converted into ferric hydroxide and dopamine is converted into polydopamine, and thus the ferric hydroxide and the polydopamine are together loaded on a surface of an adsorption carrier; and
(3) the adsorption carrier loaded with the ferric hydroxide and the polydopamine is heated to 800° C. under nitrogen and held for 5 h, and then naturally cooled to obtain a solid adsorbent C.

### Solid Adsorbent D:

(1) 100 parts of silica gel powder are dispersed in 300 parts of solution containing 0.1 mol/L copper chloride and 0.1 mol/L dopamine to form a dispersion;
(2) air is introduced into the dispersion at a rate of 100 ml/min, and a 0.5 mol/L sodium hydroxide solution is dropwise added to regulate the pH of the dispersion to alkalinity, such that the copper chloride is converted into copper hydroxide and dopamine is converted into polydopamine, and thus the copper hydroxide and the polydopamine are together loaded on a surface of an adsorption carrier; and
(3) the adsorption carrier loaded with the copper hydroxide and the polydopamine is heated to 600° C. under nitrogen and held for 3 h, and then naturally cooled to obtain a solid adsorbent D.

### Solid Adsorbent E:

(1) 100 parts of silica gel powder are dispersed in 300 parts of solution containing 0.08 mol/L ferric chloride, 0.02 mol/L copper chloride, and 0.1 mol/L dopamine to form a dispersion;
(2) air is introduced into the dispersion at a rate of 100 ml/min, and a 0.5 mol/L sodium hydroxide solution is dropwise added to regulate the pH of the dispersion to alkalinity, such that the ferric chloride is converted into the ferric hydroxide, the copper chloride is converted into the copper hydroxide and dopamine is converted into polydopamine, and thus the ferric hydroxide, the copper hydroxide and the polydopamine are together loaded on a surface of an adsorption carrier; and
(3) the adsorption carrier loaded with the ferric hydroxide, the copper hydroxide and the polydopamine is heated to 800° C. under nitrogen and held for 5 h, and then naturally cooled to obtain a solid adsorbent D.

### Solid Adsorbent F:

(1) 100 parts of silica gel powder are dispersed in 300 parts of solution containing 0.1 mol/L zinc chloride to form a dispersion;
(2) air is introduced into the dispersion at a rate of 100 ml/min, and a 0.5 mol/L sodium hydroxide solution is dropwise added to regulate the pH of the dispersion to alkalinity, such that the zinc chloride is converted into zinc hydroxide to be loaded on a surface of an adsorption carrier; and
(3) the adsorption carrier loaded with the zinc hydroxide is heated to 500° C. under nitrogen and held for 8 h, and then naturally cooled to obtain a solid adsorbent F.

### [Preparation of Adsorption Composition]

### Adsorption Composition 1:

An adsorption composition 1 includes 40 wt % of 1-butyl-3-methylimidazole trifluoromethanesulfonate and 60 wt % of solid adsorbent A by weight.

### Adsorption Composition 2:

An adsorption composition 2 includes 40 wt % of 1-butyl-3-methylimidazole trifluoromethanesulfonate and 60 wt % of solid adsorbent B by weight.

### Adsorption Composition 3:

An adsorption composition 3 includes 40 wt % of 1-butyl-3-methylimidazole trifluoromethanesulfonate and 60 wt % of solid adsorbent C by weight.

### Adsorption Composition 4:

An adsorption composition 4 includes 40 wt % of 1-butyl-3-methylimidazole trifluoromethanesulfonate and 60 wt % of solid adsorbent D by weight.

### Adsorption Composition 5:

An adsorption composition 5 includes 40 wt % of 1-butyl-3-methylimidazole trifluoromethanesulfonate and 60 wt % of solid adsorbent E by weight.

### Adsorption Composition 6:

An adsorption composition 6 includes 40 wt % of 1-butyl-3-methylimidazole dicyanamide and 60 wt % of solid adsorbent A by weight.

### Adsorption Composition 7:

An adsorption composition 7 includes 40 wt % of 1-ethyl-2,3-methylimidazole tetrafluoroborate and 60 wt % of solid adsorbent A by weight.

### Adsorption Composition 8:

An adsorption composition 8 includes 40 wt % of 1-ethyl-3-methylimidazole chloroaluminate and 60 wt % of solid adsorbent A by weight.

### Adsorption Composition 9:

An adsorption composition 9 includes 40 wt % of 1-octyl-2,3-dimethylimidazolium hexafluorophosphate and 60 wt % of solid adsorbent A by weight.

### Adsorption Composition 10:

An adsorption composition 10 includes 40 wt % of 1-butyl-3-methylimidazole trifluoromethanesulfonate and 60 wt % of solid adsorbent F by weight.

### Embodiments 1 to 9

As shown in FIG. 2, a boron trichloride purification system includes a feed gas tank 100, an adsorption assembly 200, a trapping assembly 300 and a product tank 400 which are connected in sequence by pipelines.

Wherein
the adsorption assembly 200 includes a plurality of adsorbers 210 which are connected with each other in series;
the adsorption assembly includes a primary adsorber 211, a secondary adsorber 212 and a tertiary adsorber 213 which are connected in sequence;
A volume of the primary adsorber 211 is 50 L, a design pressure is 8.0 MPa, a maximum working temperature is 480° C., and the primary adsorber is filled with a 13× molecular sieve;
A volume of the secondary adsorber 212 is 50 L, a design pressure is 8.0 MPa, a maximum working temperature is 480° C., the secondary adsorber is filled with the adsorption compositions 1 to 9 as shown above;
A volume of the tertiary adsorber 213 is 50 L, a design pressure is 8.0 MPa, a maximum working temperature is 480° C., and the tertiary adsorber is filled with activated carbon.

The trapping assembly 300 includes a trapping bottle 310 connected with the adsorption assembly 200, and a cold trap 320 is arranged outside the trapping bottle 310 in a sleeving manner.

### Application Examples 1 to 9

A boron trichloride feed gas used in the present disclosure is commercially available 3N-grade (purity: 99.9%) boron trichloride.

A method for purifying electronic grade boron trichloride includes the following steps:
a boron trichloride purification system in Embodiments 1 to 9 is vacuumized to remove air from adsorbers, and then a high-purity boron trichloride gas is introduced to remove a residual impurity gas therein; a feed gas tank 100 is heated to 25° C. in a water bath, then the feed gas tank 100 is regulated by a valve to maintain its internal pressure at 1.8 MPa, such that the boron trichloride passes through a primary adsorber 211, a secondary adsorber 212 and a tertiary adsorber 213 at a flow rate of 2 L/min under pressure of 0.15 MPa in sequence, and comes into contact with a 13× molecular sieve, adsorption compositions 1 to 9 and activated carbon, respectively; next, the boron trichloride obtained after adsorption is introduced into a trapping bottle 310 of a liquid nitrogen-filled cold bath, and the trapping bottle 310 is vacuumized to remove oxygen, nitrogen and other impurities, and finally heated to room temperature; and the boron trichloride is introduced into a product tank 400 to obtain an electronic-grade boron trichloride gas.

### Comparative Application Example 1

Comparative Application Example 1 differs from Application Examples 1 to 9 in that a secondary adsorber 212 is filled with an adsorption composition 10.

### Comparative Application Example 2

Comparative Application Example 2 differs from Application Examples 1 to 9 in that a secondary adsorber 212 is merely filled with a solid adsorbent A.

### Comparative Application Example 3

Comparative Application Example 3 differs from Application Examples 1 to 9 in that a secondary adsorber 212 is merely filled with 1-butyl-3-methylimidazolium trifluoromethanesulfonate.

The absorption effect of the absorption composition is compared by testing the content of the impurity gas in the boron trichloride gas obtained after purification.

### [Performance Test Result]

The contents of the impurity gas in the boron trichloride gas obtained by purification in Application Examples 1 to 9 and Comparative Application Examples 1 to 3 are shown in Table 1.

TABLE 1

| | | | | | Solid |
|---|---|---|---|---|---|
| | Content of impurity gas | | | | particle |
| | O₂ | CO | CO₂ | HCl | (mg/m³) |
| Boron | 266 ppm | 58 ppm | 149 ppm | 73 ppm | 0.39 |
| trichloride | | | | | |
| feed gas | | | | | |
| Application | 56 ppb | 21 ppb | 28 ppb | 16 ppb | 0.012 |
| Example 1 | | | | | |
| Application | 63 ppb | 19 ppb | 31 ppb | 15 ppb | 0.010 |
| Example 2 | | | | | |
| Application | 82 ppb | 29 ppb | 37 ppb | 28 ppb | 0.014 |
| Example 3 | | | | | |
| Application | 41 ppb | 15 ppb | 16 ppb | 7 ppb | 0.009 |
| Example 4 | | | | | |
| Application | 49 ppb | 18 ppb | 21 ppb | 12 ppb | 0.011 |
| Example 5 | | | | | |
| Application | 58 ppb | 24 ppb | 31 ppb | 19 ppb | 0.015 |
| Example 6 | | | | | |
| Application | 52 ppb | 21 ppb | 25 ppb | 16 ppb | 0.012 |
| Example 7 | | | | | |
| Application | 53 ppb | 23 ppb | 27 ppb | 18 ppb | 0.011 |
| Example 8 | | | | | |
| Application | 57 ppb | 20 ppb | 26 ppb | 15 ppb | 0.013 |
| Example 9 | | | | | |
| Comparative | 312 ppb | 126 ppb | 163 ppb | 108 ppb | 0.065 |
| Application | | | | | |
| Example 1 | | | | | |
| Comparative | 82 ppm | 16 ppm | 35 ppm | 42 ppm | 0.12 |
| Application | | | | | |
| Example 2 | | | | | |
| Comparative | 238 ppm | 36 ppm | 119 ppm | 69 ppm | 0.082 |
| Application | | | | | |
| Example 3 | | | | | |

It can be known from the above table that the adsorption composition prepared according to the present disclosure has an excellent adsorption capacity for the impurity gas, and the content of the impurity gas in the boron trichloride gas after adsorption treatment is decreased greatly, which can reach the ppb level.

In terms of details, after comparison of Application Examples 1 to 5, it can be known that in the present disclosure, the use of different metal oxides has a certain effect on the adsorption of the impurity gas, wherein the adsorption performance is the optimum after use of the copper oxide; after single use of the iron oxide, the adsorption performance is the worst in several embodiments; however, after a certain amount of copper oxide is doped into the iron oxide, the adsorption effect thereof can be improved effectively. This indicates that the copper oxide has a synergistic effect on other metal oxides.

After comparison between Application Example 1 and Application Examples 6 to 9, we find that the difference of these application examples lies in that the types of the used ionic liquids are different, however, from the actual performance, we find that the types of the ionic liquids have a little effect on the final adsorption effects.

Application Example 1 differs from Comparative Application Example 1 in that the outside surface of the solid adsorbent is not coated with the carbon layer, and consequently the adsorption capacity thereof is decreased significantly.

As only the solid adsorbent A is contained in Comparative Application Example 2, the impurity gas in the boron trichloride is hard to adsorb, and especially for hydrogen chloride gas, the adsorption effect thereof is especially non-obvious. As only the ionic liquid other than the solid adsorbent is contained in Comparative Application Example 2, the adsorption effect thereof is the worst. This indicates that the adsorption effect of the solid adsorbent is better than that of the ionic liquid, and after the ionic liquid is combined with the solid adsorbent, the adsorption effect on impurities in the boron trichloride can be greatly improved.

What is claimed is:

1. An adsorption composition, comprising
an ionic liquid, and a solid adsorbent dispersed in the ionic liquid;
wherein the solid adsorbent comprises an adsorption carrier and a metal oxide loaded on a surface of the adsorption carrier; and
an outside surface of the solid adsorbent is further coated with a carbon layer.

2. The adsorption composition according to claim 1, wherein
the ionic liquid comprises one or a combination of more of an imidazolium ionic liquid, a quaternary ammonium ionic liquid, a quaternary phosphonium ionic liquid, a pyrrolidine ionic liquid and a piperidine ionic liquid.

3. The adsorption composition according to claim 1, wherein
the adsorption carrier comprises one or a combination of more of silica gel powder, diatomaceous earth, laminated graphite and activated carbon.

4. The adsorption composition according to claim 1, wherein
the metal oxide comprises one or more of oxides of zinc, aluminum, magnesium, iron, manganese and copper.

5. The adsorption composition according to claim 1 or 4, wherein
the metal oxide must contain the copper oxide.

6. A method for preparing the adsorption composition according to any one of claims 1 to 5, wherein
the method comprises the following steps:
(1) dispersing an adsorption carrier into a solution containing a soluble metal salt and a carbon-containing monomer to form a dispersion;
(2) regulating a pH of the dispersion to alkalinity, such that the soluble metal salt is converted into a metal hydroxide and the carbon-containing monomer is converted into a carbon precursor, thus the metal hydroxide and the carbon precursor are together loaded on a surface of the adsorption carrier;
(3) performing heat treatment to the adsorption carrier loaded with the metal hydroxide and the carbon precursor in an inert atmosphere, to obtain a solid adsorbent; and
(4) dispersing the solid adsorbent into an ionic liquid to form the adsorption composition.

7. The method according to claim 6, wherein
the heat treatment in step (3) is conducted at 500° C.-800° C. for 3-8 h.

8. A method for purifying electronic-grade boron trichloride, wherein
the method comprises the following steps:
(S.1), filling the adsorption composition according to any one of claims 1 to 5 into adsorbers;
(S.2), vacuumizing the adsorbers to remove air from the adsorbers, and then introducing a high-purity boron trichloride gas; and
(S.3), introducing a boron trichloride feed gas into the adsorbers, such that the boron trichloride feed gas is in contact with the adsorption composition, and collecting a gas flowing out of the adsorbers to obtain an electronic-grade boron trichloride gas.

9. A boron trichloride purification system, wherein
it comprises a feed gas tank, an adsorption assembly, a trapping assembly and a product tank which are connected in sequence by pipelines; and
the adsorption assembly comprises a plurality of adsorbers which are connected with each other in series, and at least one adsorber is filled with the adsorption composition according to any one of claims 1 to 5.

10. The boron trichloride purification system according to claim 9, wherein
the adsorption assembly comprises a primary adsorber, a secondary adsorber and a tertiary adsorber which are connected in sequence;
the primary adsorber and the tertiary adsorber are filled with any one of activated carbon, a 13× molecular sieve, and a mordenite molecular sieve, respectively;
the secondary adsorber is filled with the adsorption composition according to any one of claims 1 to 5;
the trapping assembly comprises a trapping bottle connected with the adsorption assembly; and
a cold trap is arranged outside the trapping bottle in a sleeving manner.
